(19) United States
(12) Patent Application Publication
(10) Pub. No.: US 2017/0109773 A1
(43) Pub. Date: Apr. 20, 2017

(54) COMPREHENSIVE, SYSTEMIC CUSTOMER LOYALTY PROGRAM

(71) Applicant: MasterCard International Incorporated, Purchase, NY (US)

(72) Inventors: Deepankar Bhagat, Chesterfield, MO (US); Mark N. Savoye, Hartsdale, NY (US); Prashant Sharma, Madison, NJ (US)

(21) Appl. No.: 14/885,506

(22) Filed: Oct. 16, 2015

(51) Int. Cl. G06Q 30/02; G06Q 20/40; G06Q 20/20; G06Q 50/00

(52) U.S. Cl. CPC G06Q 30/0226; G06Q 50/01; G06Q 20/40; G06Q 20/206

(57) ABSTRACT

A method includes establishing a loyalty points account for an account holder. The account holder may be allowed to access value held in the loyalty points account via a transaction authorized and cleared through a payment account system.

### BACKGROUND

Customer loyalty programs are in widespread use. Many are sponsored by a single retail chain and provide benefits only in connection with purchases from that chain. Other customer loyalty programs involve cooperation among various merchants. For example, groups of travel and entertainment merchants are in some cases led by airlines as the chief sponsors of loyalty programs that allow for redemption of “miles” earned among all members of the participating group of merchants.

The present inventors have now recognized an opportunity for a customer loyalty system that may be more comprehensive, accessible and attractive to users than existing programs.

### BRIEF DESCRIPTION OF THE DRAWINGS

Features and advantages of some embodiments of the present disclosure, and the manner in which the same are accomplished, will become more readily apparent upon consideration of the following detailed description taken in conjunction with the accompanying drawings, which illustrate preferred and exemplary embodiments and which are not necessarily drawn to scale, wherein:

FIG. 1 is a block diagram that illustrates a conventional payment system.

FIG. 2 is a block diagram that illustrates an overview of an environment in which conventional payment systems are operated.

FIG. 3 is a block diagram that illustrates a customer loyalty system according to some embodiments.

FIGS. 4-6 are block diagrams that illustrate computer systems that may serve as components of the customer loyalty system of FIG. 3.

FIG. 7 is a block diagram that illustrates a typical merchant point of sale terminal that may be provided according to some embodiments as part of the customer loyalty system of FIG. 3.

FIGS. 8-11 are flow charts that illustrate processes that may be performed in the customer loyalty system of FIG. 3.

### DETAILED DESCRIPTION

In general, and to introduce concepts of embodiments of this disclosure, a customer loyalty system may have an operator of a payment system as a lead sponsor and chief organizer. Additional sponsoring entities may include one or more merchants (including, for example, small and medium size merchants—“SMEs”), transaction acquirers, payment account issuers, payment facilitators and other parties involved with operation of payment systems. In addition or alternatively, other service providers, including social media operators or other web-based services may be included as sponsors.

In some embodiments, a given customer's points, funded by all participating sponsors, may be credited to a single loyalty points account that is issued as a payment account by a payment account issuer in cooperation with a payment system operator that is the chief organizer of the loyalty system. The resulting payment account may, in effect, function as a pre-paid payment account so that the customer can access the loyalty benefits in substantially conventional payment account transactions routed through the payment system operated by the chief organizer. In other words, the customer can use his or her card or other payment device issued through the program to access his/her loyalty points account through purchase transactions at the point of sale and/or in e-commerce transactions, including via merchants who have no connection to the loyalty program but who are simply acceptors of the brand of payment card that corresponds to the chief organizer.

In some embodiments, issuers of payment accounts for a different, unrelated payment system may be sponsors (funders of loyalty points) for the above-described loyalty system.

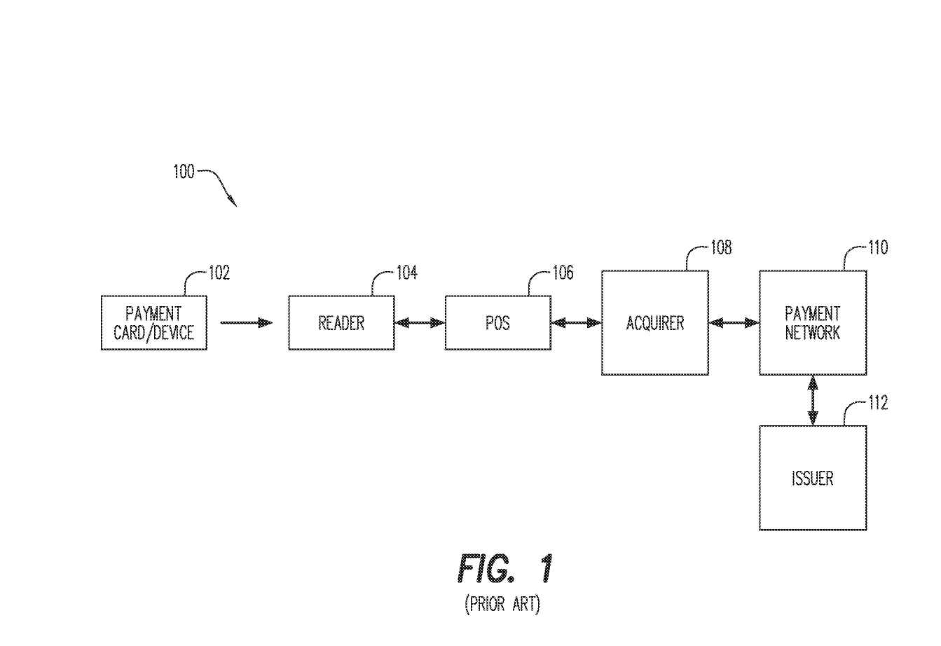

FIG. 1 is a block diagram that illustrates a conventional payment system 100.

The system 100 includes a conventional payment card/device 102 (which may alternatively be a conventional payment-enabled mobile device that stores a payment card account number and runs a payment applet; other form factors for the payment device, such as a fob, are also possible). The system 100 further includes a reader component 104 associated with a POS terminal 106. In some known manner (depending on the type of the payment card/device 102) the reader component 104 is capable of reading the payment card account number and other information from the payment card/device 102.

The reader component 104 and the POS terminal 106 may be located at the premises of a retail store and operated by a sales associate of the retailer for the purpose of processing retail transactions. The payment card/device 102 is shown in FIG. 1 to be interacting with the reader component 104 and the POS terminal 106 for the purpose of executing such a transaction.

A computer 108 operated by an acquirer (acquiring financial institution; sometimes referred to as a “transaction acquirer”) is also shown as part of the system 100 in FIG. 1. The acquirer computer 108 may operate in a conventional manner to receive a payment account transaction authorization request message (sometimes referred to as an “authorization request”) for the transaction from the POS terminal 106. The acquirer computer 108 may route the authorization request via a payment network 110 to the server computer 112 operated by the issuer of a payment account that is associated with the payment card/device 102. As is also well known, the payment account transaction authorization response message (also referred to as an “authorization response”) generated by the payment account issuer server computer 112 may be routed back to the POS terminal 106 via the payment network 110 and the acquirer computer 108.

One well known example of a payment network is referred to as the “Banknet” system, and is operated by MasterCard International Incorporated, which is the assignee hereof.

The payment card issuer server computer 112 may be operated by or on behalf of a financial institution (“FI”) that issues payment accounts to individual users and other entities. For example, the payment account issuer server computer 112 may perform such functions as (a) receiving and responding to requests for authorization of payment account transactions to be charged to payment accounts issued by the FI; and (b) tracking and storing transactions and maintaining account records.

The components of the system 100 as depicted in FIG. 1 are only those that are needed for processing a single transaction. A typical payment system may process many purchase transactions (including simultaneous transactions) and may include a considerable number of payment account issuers and their computers, a considerable number of acquirers and their computers, and numerous merchants and their POS terminals and associated proximity reader components. The system may also include a very large number of payment account holders, who carry payment cards or other devices for initiating payment transactions by presenting an associated payment account number to the reader component of a POS terminal.

The above description of a typical payment account transaction was presented in the context of an in-store purchase transaction. As is also well-known, many payment account transactions also occur in the context of e-commerce purchase transactions. In those cases, for example, a customer may interact with an e-commerce server computer via a mobile device, personal computer, etc., and may enter payment account information into a data entry page to enable the e-commerce server computer to generate an authorization request. As in the case illustrated in FIG. 1, the authorization request may be routed to the account issuer via the acquirer and the payment network, and the authorization response may be routed back from the account issuer via the payment network and the acquirer.

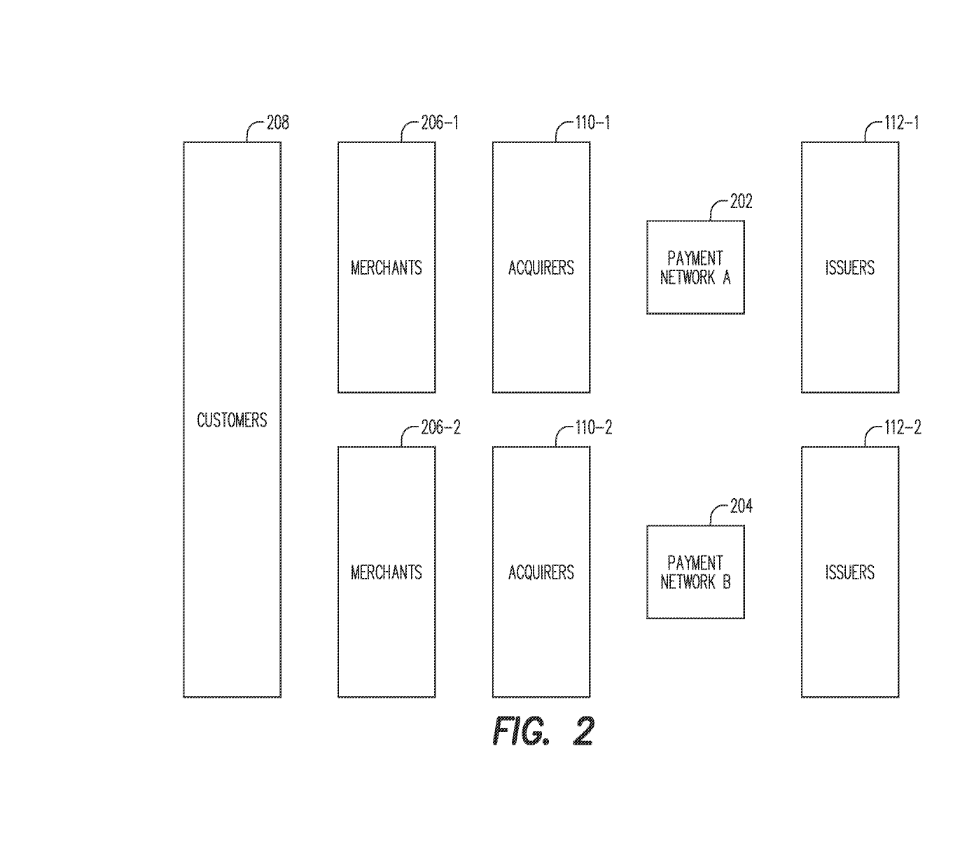

FIG. 2 is a block diagram that fills in additional background with respect to the environment in which conventional payment account transactions may occur. One circumstance brought out in FIG. 2 is that the conventional world of payment account transactions includes more than one payment network, represented by blocks 202 and 204. Block 202, for example, may be the above-mentioned Banknet system operated by MasterCard International Incorporated, the assignee hereof. As is well-known, the latter payment network handles payment account transactions for payment accounts branded with the “MASTERCARD” brand. Block 204 may be considered to represent another payment network, which handles payment account transactions for payment accounts branded with a different brand.

Block 112-1 in FIG. 2 represents issuers of payment accounts for which transactions are handled through the payment network 202. Block 112-2 represents issuers of payment account for which transactions are handled through the payment network 204. In real-world situations, some financial institutions or other payment account issuers may fall into both categories of account issuers—that is, the membership of blocks 112-1 and 112-2 may overlap.

Block 206-1 in FIG. 2 represents merchants that accept payment account transactions to be handled through payment network 202. Block 206-2 represents merchants that accept payment account transactions to be handled through payment network 204. It is again well-known that many merchants accept more than one brand of payment account transaction, so that again the membership of blocks 206-1 and 206-2 may overlap.

Block 110-1 represents financial institutions that have banking relationships with merchants 206-1 and route authorization requests through payment network 202. Block 110-2 represents financial institutions that have banking relationships with merchants 206-2 and route authorization requests through payment network 204. Again there may be overlap in the memberships of the categories of entities represented by block 110-1 and 110-2. In some situations, payment processors, payment facilitators, or other entities may stand in for the acquirers 110-1 and 110-2.

Block 208 represents the vast universe of individuals and other entities that hold payment accounts for which transactions are accepted by the merchants 206-1, 206-2. It is, of course, frequently the case that account holders hold payment accounts of more than one brand. Moreover, the real-world environment of payment account transactions is more complex than that illustrated in FIG. 2, and includes, for example, more than two different payment networks.

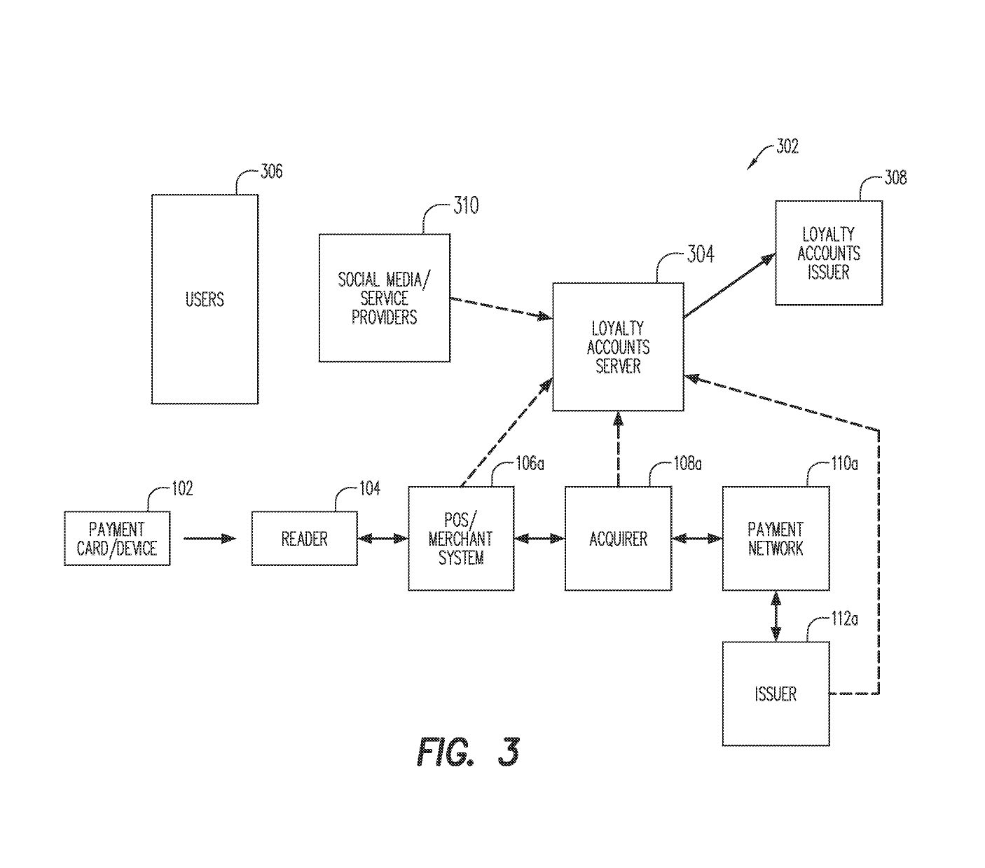

FIG. 3 is a block diagram that illustrates a customer loyalty system 302 according to some embodiments. The customer loyalty system 302 of FIG. 3 includes all the components/participants described above in connection with FIG. 1, and includes other components/participants as well, as will be described below. Moreover, as will be seen, components/participants that were described in connection in FIG. 1 may have additional roles and/or functions in the customer loyalty system 302 of FIG. 3.

Thus, the customer loyalty system 302 includes a POS/merchant system 106a, which may have all the functionality of the POS terminal 106 described in connection with FIG. 1 and additional functionality in accordance with teachings of this disclosure. Further, the customer loyalty system 302 includes a transaction acquirer 108a, which may have all the functionality of the acquirer 108 described in connection with FIG. 1 and additional functionality in accordance with teachings of this disclosure. Still further, the customer loyalty system 302 includes a payment network 110a, which may have all the functionality of the payment network 110 described in connection with FIG. 1, and in some embodiments may have further functionality in accordance with teachings of this disclosure. In addition, the customer loyalty system 302 includes an account issuer 112a, which may have all the functionality of the issuer 112 described in connection with FIG. 1, and additional functionality in accordance with teachings of this disclosure.

FIG. 3 also shows a payment card/device 102 and a reader 104 like those described above in connection with FIG. 1.

One important component of the customer loyalty system 302 is a loyalty accounts server computer 304. Details of characteristics and functionality of the loyalty accounts server computer 304 will be described below. In some embodiments, the loyalty accounts server computer 304 may be operated by the operator (not separately shown) of the payment network 110a in connection with the operator's role as chief organizer of the customer loyalty system 302. In some embodiments, additional functionality of the POS/merchant system 106a, transaction acquirer 108a, payment network 110a and/or the account issuer 112a may include reporting payment account transactions to the loyalty accounts server computer 304 so that loyalty points can be credited to customer loyalty accounts of users (block 306) of the customer loyalty system 302. System participants such as merchants, transaction acquirers, payment facilitators, account issuers and/or the operator of the payment network may provide funding to support the crediting of loyalty points to the customer loyalty accounts. Thus, any one or more of the types of participants named in the previous sentence may be sponsors of the loyalty points program made possible by the customer loyalty system 302. Additional types of sponsors may include social media and/or service providers (block 310), including, for example, social media platforms, mobile telecommunications and/or other communications carriers, wallet service providers, internet search services, media subscription services, free web information destinations and portals and other online advertising platforms, etc.

According to embodiments of the customer loyalty system 302, the customer loyalty accounts may take the form of payment accounts issued by a loyalty accounts issuer 308 that has a cooperative relationship with the organizer of the customer loyalty system 302. The loyalty accounts issuer 308 may be a financial institution that issues payment accounts, and the customer loyalty accounts issued according to embodiments of the customer loyalty system 302 may be payment accounts that functionally operate in a similar manner (in terms of payment account transactions) to the types of payment accounts used in the payment system 100 shown in FIG. 1. For example, when a user 306 signs up for a customer loyalty account via the loyalty accounts server computer 304, the loyalty accounts server computer 304 may instruct the loyalty accounts issuer 308 to issue a customer loyalty account/payment account to the user. The issuance of the latter account by the loyalty accounts issuer 308 may include the loyalty accounts issuer 308 sending a substantially conventional payment card to the user. The user may then present the card (or the corresponding account number) to merchants to initiate payment account transactions to access the value of loyalty points that have been credited to the account. Embodiment of the payment credentials in a form other than a card may also occur in addition to or instead of issuance of a physical payment card. For example, the payment credentials may be loaded into or made accessible via a payment-enabled mobile device. In addition or alternatively, the payment credentials that correspond to the customer loyalty account/payment account may be included in the user's digital wallet.

In some embodiments, the customer loyalty account/payment account may be identified by a primary account number (PAN). In addition or alternatively, the customer loyalty account/payment account may be identified, at least for some purposes, by a “payment token”, as that term is used in the EMV Payment Tokenization Standard (March 2014; http://www.emvco.com/specifications.aspx?id=263). Either a PAN or a payment token may hereinafter be referred to as an “account identifier.”

In some embodiments, an issuer (not shown in FIG. 3) of payment accounts that are handled by a different payment network (i.e., issued under a different brand) from the payment network 110a may be a sponsor of loyalty points for the customer loyalty system 302. Thus, a transaction handled via payment network 204 (FIG. 2) and related to a payment account issued by one of the issuers 112-2, may give rise to loyalty points (funded by that issuer 112-2) credited to a customer loyalty account/payment account issued by the loyalty accounts issuer 308 (FIG. 3) and accessible via the payment network 110a (FIG. 3), which for present purposes is assumed to substantially coincide with the payment network 202 shown in FIG. 2. In other words, an account issuer under one payment network brand may be a loyalty points sponsor for a customer loyalty program organized by a different payment network. In such cases, the account issuer in question may report payment transactions for the user/loyalty program member to the loyalty accounts server computer 304 to cause crediting of loyalty points to the customer loyalty account/payment account issued by the loyalty accounts issuer 308.

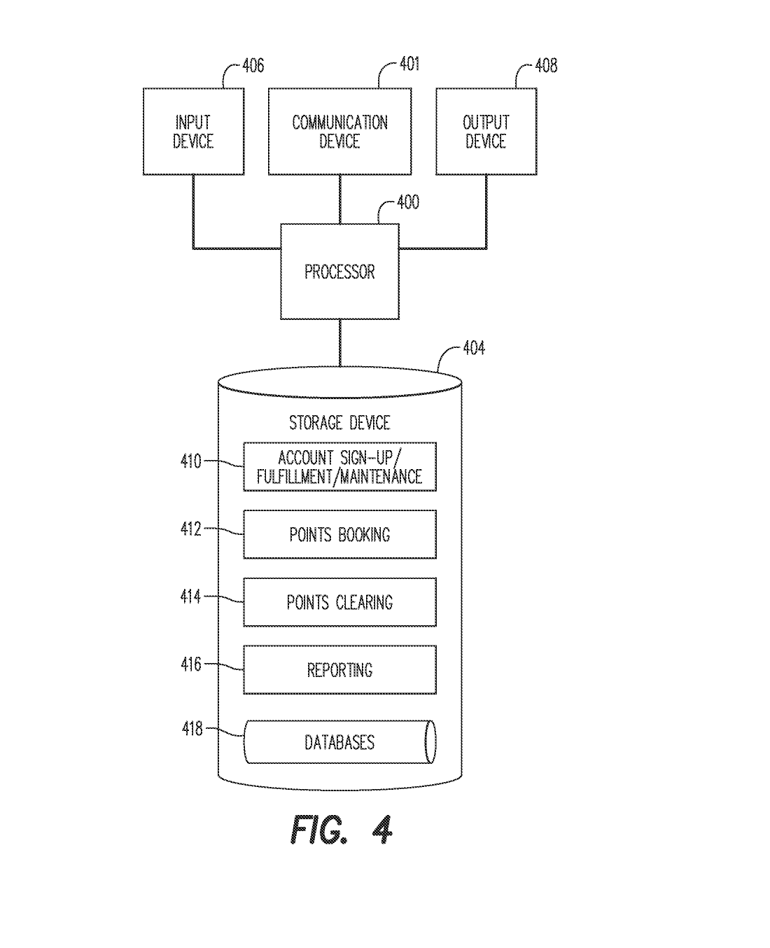

FIG. 4 is a block diagram illustration of an example embodiment of the loyalty accounts server computer 304.

The loyalty accounts server computer 304 may be constituted, in its hardware aspects, by server computer and/or mainframe computer hardware, and may be controlled by software to cause it to operate in accordance with aspects of the present disclosure.

The loyalty accounts server computer 304 may include a computer processor 400 operatively coupled to a communication device 401, a storage device 404, an input device 406 and an output device 408. The storage device 404, the communication device 401, the input device 406 and the output device 408 may all be in communication with the processor 400.

The computer processor 400 may be constituted by one or more single or multiple core processors or processing units. Processor 400 operates to execute processor-executable steps, contained in program instructions described below, so as to control the loyalty accounts server computer 304 to provide desired functionality.

Communication device 401 may be used to facilitate communication with, for example, other devices (such as devices operated by the sponsors/funders of loyalty points in the customer loyalty system 302; and/or one or more computers operated by the loyalty accounts issuer 308; and/or one or more devices operated by the users 306). Communication device 401 may include numerous communication ports (not separately shown) to accommodate numerous simultaneous interactions and/or receipt and/or transmission of numerous data communication messages, and may be capable of engaging in data communication over conventional computer-to-computer data networks.

Input device 406 may comprise one or more of any type of peripheral device typically used to input data into a computer. For example, the input device 406 may include a keyboard and a mouse. Output device 408 may comprise, for example, a display and/or a printer.

Storage device 404 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as so-called flash memory.

Storage device 404 stores one or more programs for controlling processor 400. The programs comprise program instructions that contain processor-executable process steps of loyalty accounts server computer 304, including, in some cases, process steps that constitute processes provided in accordance with principles of the present disclosure, as described herein.

The programs may include one or more conventional operating systems (not shown) that control the processor 400 so as to manage and coordinate activities and sharing of resources in the loyalty accounts server computer 304, and to serve as a host for application programs (described below) that run on the loyalty accounts server computer 304.

The programs stored in the storage device 404 may also include a user enrollment application program 410. The user enrollment application program 410 may control the processor 400 to enable the loyalty accounts server computer 304 to permit users 306 to access a website hosted by the loyalty accounts server computer 304 to permit the users to sign up/enroll for customer loyalty accounts in the customer loyalty system 302. In a typical enrollment interaction between a user and the loyalty accounts server computer 304, the loyalty accounts server computer 304 may prompt the user to enter his/her name and contact information. In some embodiments, demographic information may also be collected. In some embodiments, the enrollment process may resemble application for a payment account, except that information related to creditworthiness may not be required.

According to other functionality that may be provided by the user enrollment application program 410, the loyalty accounts server computer 304 may be programmed to take steps necessary to fulfill the user's enrollment in the customer loyalty system. This may include, for example, transmitting a message from the loyalty accounts server computer 304 to the loyalty accounts issuer 308 to instruct the loyalty accounts issuer 308 to open the customer loyalty account/payment account requested by the user.

According to additional functionality that may be provided by the user enrollment application program 410, loyalty account maintenance functions may be included, so that the loyalty accounts server computer 304 is programmed to allow typical account maintenance activities such as, for example, updates to the user's contact information or user profile.

The storage device 404 may also store a loyalty points booking application program 412 to control the processor 400 to enable the loyalty accounts server computer 304 to receive and implement instructions from loyalty points sponsors/funders to credit loyalty points to users in respect of particular transactions. In some embodiments, the instructions may simply be in the form of reports of transactions that qualify for award of customer loyalty points. The loyalty accounts server computer 304 may respond to such instructions/transaction reports by instructing the loyalty accounts issuer 308 to make appropriate credits to the users' accounts maintained by the loyalty accounts issuer 308.

The storage device 404 may also store a clearing application program 414 to program the loyalty accounts server computer 304 to manage clearing operations between the funders of loyalty points, on one hand, and the loyalty accounts issuer 308, on the other hand.

Another application program that may be stored by the storage device 404 is indicated by reference numeral 416 in FIG. 4, and may program the loyalty accounts server computer 304 to provide reporting to the user 306 concerning credits (and perhaps also charges) to the user's accounts.

The storage device 404 may also store, and the loyalty accounts server computer 304 may also execute, other programs, which are not shown. For example, such programs may include an administrative reporting application, which may respond to requests from system administrators for reports on the activities performed by the loyalty accounts server computer 304. The other programs may also include, e.g., one or more data communication programs, a database management program, website hosting software, device drivers, etc.

Reference numeral 418 in FIG. 4 indicates one or more databases that are maintained by the loyalty accounts server computer 304 on the storage device 404 as needed to support operation of the loyalty accounts server computer 304.

The application programs of the loyalty accounts server computer 304 as described above may be combined in some embodiments, as convenient, into one, two or more application programs. In addition or alternatively, functionality described as part of a single program may, in some embodiments, be distributed among two or more different programs.

Other components of the customer loyalty system 302 shown in FIG. 3 may exhibit the same hardware architecture and types of components as described above with respect to the loyalty accounts server computer 304, as will be seen from subsequent drawings and descriptions thereof.

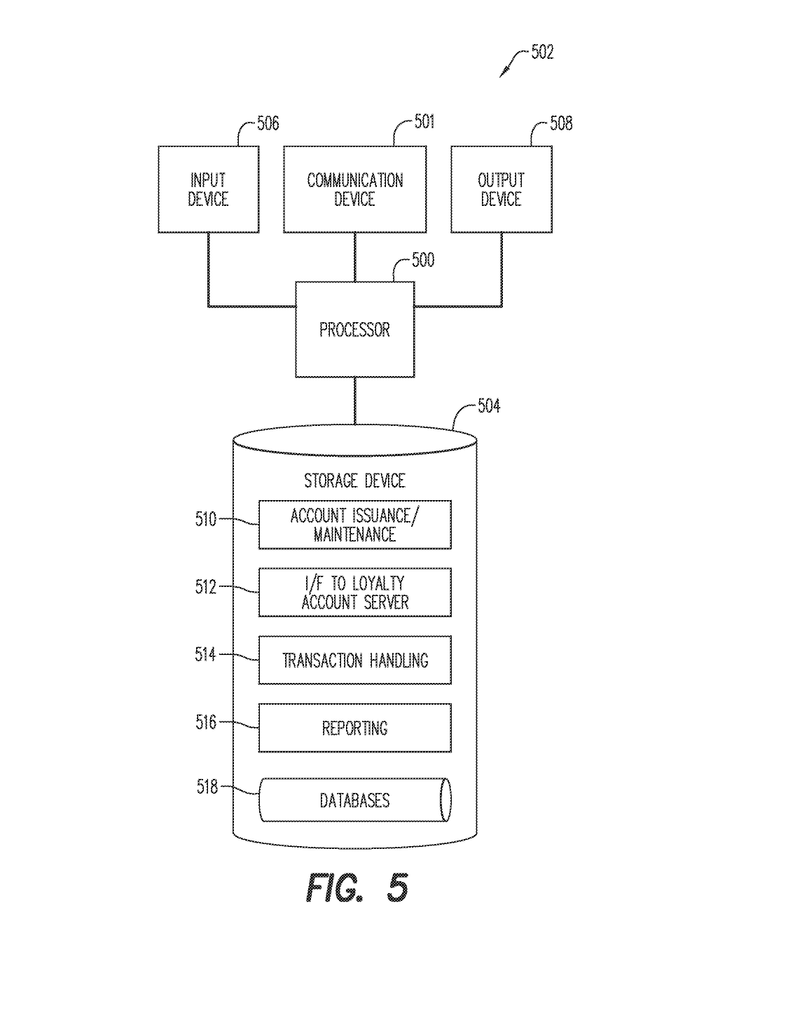

For example, FIG. 5 is a block diagram of an account issuer computer 502, which may be operated by or on behalf of the loyalty accounts issuer 308 to implement functions and roles of the loyalty accounts issuer 308 as described herein. The account issuer computer 502 may, in its hardware aspects, be constituted by computer server and/or mainframe hardware but may be programmed to provide functionality as described herein. The account issuer computer 502 may include a processor 500, a communication device 501, a storage device 504, an input device 506 and an output device 508. The communication device 501, the storage device 504, the input device 506 and the output device 508 may all be in communication with the processor 500. The descriptions of hardware components, and their general functionality, as provided above in connection with FIG. 4, are also generally applicable to like-named components shown in FIG. 5. However, the programming of the account issuer computer 502 may differ, in at least some respects, from the programming of the loyalty accounts server computer 304.

The storage device 504 may store an account issuance/maintenance application program 510. The account issuance/maintenance application program 510 may program the account issuer computer 502 to issue customer loyalty accounts/payment accounts in response to instructions received from the loyalty accounts server computer 304. In at least some respects, the account issuance/maintenance application program 510 may mirror functionality customarily provided by computers operated by payment account issuers in connection with enrollment of account holders and maintenance of records, including updating and related tasks in connection with payment accounts.

In addition, the storage device 504 may store a program 512 that supports an interface between the account issuer computer 502 and the loyalty accounts server computer 304. Part of the functionality provided by the interface program 512 may include implementing at the account issuer computer 502 instructions to credit loyalty points or corresponding monetary value to customer loyalty accounts/payment accounts maintained by the account issuer computer 502.

Still further, the storage device 504 may store a transaction handling application program 514. The transaction handling application program may handle payment account transactions (including, for example, receiving authorization requests and issuing authorization responses, and subsequent transaction clearing operations) in a manner like that customarily implemented in payment account issuers generally.

Also, the storage device 504 may store a reporting application program 516. The reporting application program 516 may program the account issuer computer 502 such that it periodically (and/or on demand) provides reports to the loyalty accounts server computer 304 so that the loyalty accounts server computer 304 is kept up to date on the status of customer loyalty accounts/payment accounts issued at the request of the loyalty accounts server computer 304.

The storage device 504 may also store, and the account issuer computer 502 may also execute, other programs, which are not shown. For example, such programs may include an administrative reporting application, which may respond to requests from system administrators for reports on the activities performed by the account issuer computer 502. The other programs may also include, e.g., one or more data communication programs, a database management program, website hosting software, device drivers, etc.

Reference numeral 518 in FIG. 5 indicates one or more databases that are maintained by the account issuer computer 502 on the storage device 504 as needed to support operation of the account issuer computer 502.

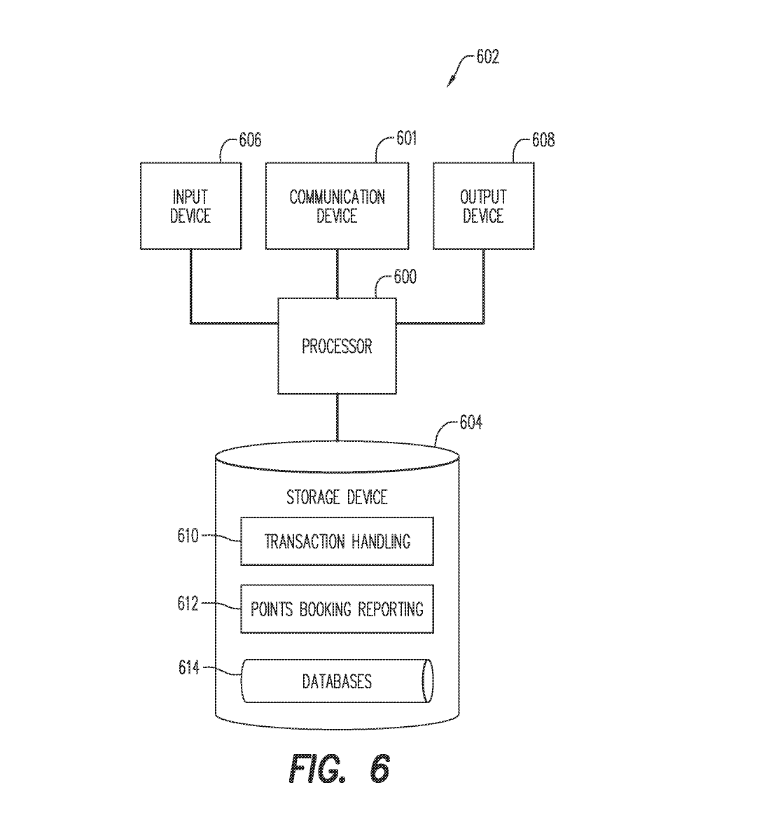

FIG. 6 is a block diagram of an acquirer computer 602, which may be operated by or on behalf of the transaction acquirer 108a shown in FIG. 3 to implement functions and roles of the transaction acquirer 108a as described herein. The acquirer computer 602 may, like the account issuer computer 502, exhibit the same hardware architecture and types of components as described above with respect to the loyalty accounts server computer 304.

The acquirer computer 602 may, in its hardware aspects, be constituted by computer server and/or mainframe hardware but may be programmed to provide functionality as described herein. The acquirer computer 602 may include a processor 600, a communication device 601, a storage device 604, an input device 606 and an output device 608. The communication device 601, the storage device 604, the input device 606 and the output device 608 may all be in communication with the processor 600. The descriptions of hardware components, and their general functionality, as provided above in connection with FIG. 4, are also generally applicable to like-named components shown in FIG. 6. However, the programming of the acquirer computer 602 may differ, in at least some respects, from the programming of the computers previously described in this disclosure.

The storage device 604 may store a transaction handling application program 610. The transaction handling application program 610 may program the acquirer computer 602 to implement functionality customarily performed by transaction acquirers in connection with payment account transactions. As will be understood from previous discussion herein, that functionality may include receiving authorization requests from merchants and routing the authorization requests via the payment network 110a to the issuer of the payment account that is being used for the transaction in question. Further, the functionality provided by the transaction handling application program 610 may include receiving authorization responses from issuers (received by the acquirer computer 602 via the payment network 110a), and forwarding the authorization responses to the pertinent merchant devices.

The storage device 604 may also store a points booking reporting program 612. The points booking reporting program 612 may program the acquirer computer 602 to aid in implementing the transaction acquirer's role in the customer loyalty program. More specifically, for example, the points booking reporting program 612 may program the acquirer computer 602 such that it reports qualifying transactions to the loyalty accounts server computer 304. As a result, the loyalty accounts server computer 304 may cause loyalty points to be credited to the customer loyalty accounts/payment accounts of users who initiated the transactions reported to the loyalty accounts server computer 304 by the acquirer computer 602. In some embodiments, the transaction acquirer 108a may fund/sponsor loyalty points to be credited to all users of the customer loyalty system who (a) have signed up for loyalty accounts with the loyalty accounts server computer 304; and (b) initiate payment account transactions that are processed via the acquirer computer 602.

The storage device 604 may also store, and the acquirer computer 602 may also execute, other programs, which are not shown. For example, such programs may include an administrative reporting application, which may respond to requests from system administrators for reports on the activities performed by the acquirer computer 602. The other programs may also include, e.g., one or more data communication programs, a database management program, website hosting software, device drivers, etc.

Reference numeral 614 in FIG. 6 indicates one or more databases that are maintained by the acquirer computer 602 on the storage device 604 as needed to support operation of the acquirer computer 602.

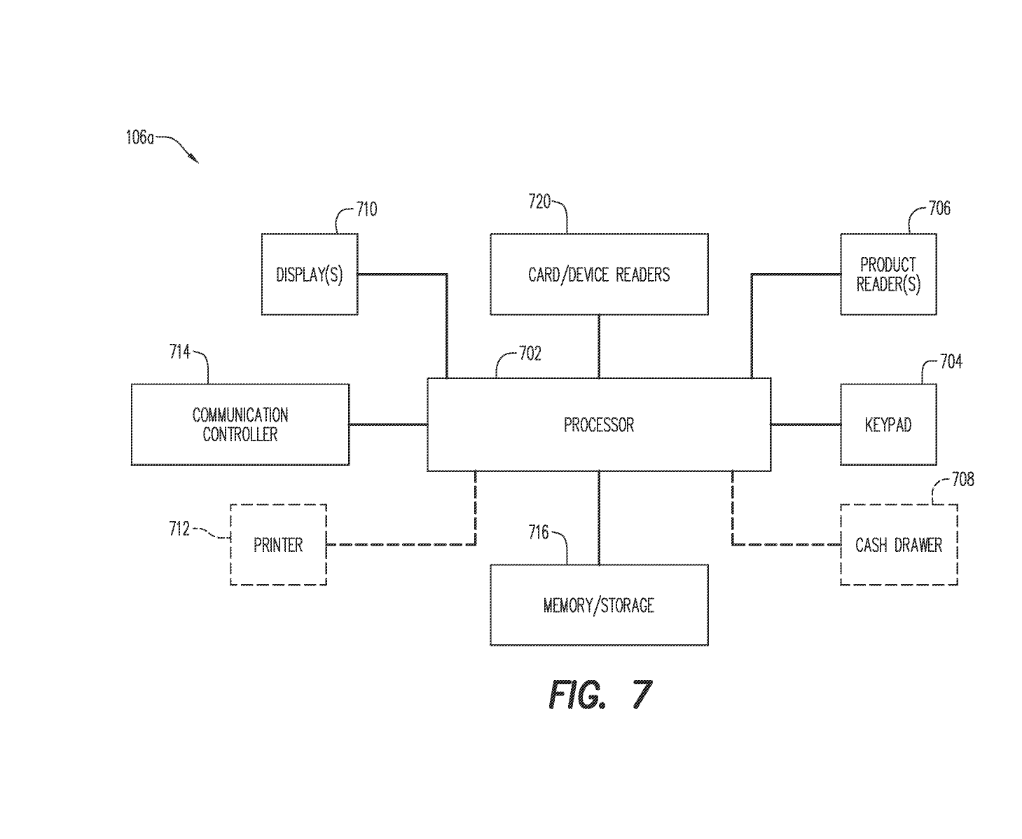

FIG. 7 is a block diagram that illustrates a typical merchant point of sale terminal 106a that may be provided according to some embodiments as part of the customer loyalty system of FIG. 3.

In some embodiments, the point of sale terminal 106a may include many or all hardware and software features typically found in POS devices. Moreover, the point of sale terminal 106a may be programmed in accordance with aspects of the present disclosure to provide functionality as described herein. Initially in regard to the point of sale terminal 106a, there will be a brief description of its hardware aspects, with continued reference to FIG. 7.

The point of sale terminal 106a may include a processing element (or elements) such as the processor 702 shown in FIG. 7. The processor 402 may, for example, be constituted by one or more single or multi-core processing units, and may operate to control the overall functioning of the point of sale terminal 106a.

The point of sale terminal 106a may also include typical peripheral components, in communication with and/or controlled by the processor 702, such as: (a) a keypad 704 for receiving input from the human operator of the POS terminal; (b) a product reader 706 for reading any form of unique product identifier, such as a barcode or RFID, that appears on, or is attached to, products brought to the terminal for purchase; (c) a cash drawer 708 for storing cash received from customers; (d) one or more displays 710 for providing output (e.g., identifying products presented for purchase and their prices, indicating sales tax due, indicating transaction subtotals and totals, etc., providing prompts to the customer and/or to the sales associate); (e) a printer 712 for printing out sales receipts; and (f) a communication controller 714 for allowing the processor 702, and hence, point of sale terminal 106a to engage in communication over data networks with other devices (e.g., the acquirer computer 602 (FIG. 6) and/or the loyalty accounts server computer 304 (FIG. 3)). (In some embodiments, at least one of the displays 710 may be a touch screen, so as to provide an input function as well as an output function.)

In addition, the point of sale terminal 106a may include one or more memory and/or data storage devices (indicated collectively at 716), which may comprise any combination of one or more of a hard disk drive, RAM (random access memory), ROM (read only memory), flash memory, etc. The memory/data storage device(s) 716 may store software and/or firmware that programs the processor 702 and the point of sale terminal 106a to perform functionality as described herein. Thus the memory/data storage device(s) 716 may be in communication with the processor 702. Further, the point of sale terminal 106a may include one or more housings (not shown) which contain and/or support one or more of the other components shown in FIG. 7.

Moreover, the point of sale terminal 106a may include one or more of the usual card-reader elements (reference numeral 720) such as a mag stripe reader, a contact IC card reader, a contactless IC card reader, etc., and/or one or more other devices for exchanging communication with other types of payment devices, such as payment-enabled smartphones.

In connection with the customer loyalty system of FIG. 3, the point of sale terminal 106a may be programmed to report eligible transactions to the loyalty accounts server computer 304. In some embodiments, every transaction may be a qualifying transaction, assuming only that the customer has previously enrolled in the loyalty program. In some embodiments, for enrolled participants in the loyalty program, transactions may be qualified whether cash or a payment card/device is used for the transaction. It may also be the case that the transaction qualifies, in connection with payment account transactions, regardless of which payment network/network brand the payment account is established in.

For example, in a cash transaction, the customer may be permitted to swipe (or otherwise present) the payment card issued by the loyalty accounts issuer 308 to be read by the point of sale terminal 106a not for payment account transaction purposes, but rather to identify the customer as a customer loyalty program participant. With that identifying information, the point of sale terminal 106a may report the transaction to the loyalty accounts server computer 304 so that the customer/user is credited with loyalty points funded/sponsored by the merchant that operates the point of sale terminal 106a.

In some embodiments, the transaction at the point of sale terminal 106a may involve two card swipes/presentations. That is, the point of sale terminal 106a may read one card (issued by the issuer 112a, FIG. 3) as a payment instrument, and may read the other card (issued by the loyalty accounts issuer 308) as a means of identifying the loyalty program participant for whom a loyalty points qualifying transaction is to be reported to the loyalty accounts server computer 304. As in the case of the cash transaction, the identifying information read by the point of sale terminal 106a from the latter card may be used by the point of sale terminal 106a to report the transaction to the loyalty accounts server computer 304 for the purpose of causing loyalty points to be credited to the customer/user. As in a conventional payment account transaction, the information read by the point of sale terminal 106a from the former card may be used to initiate a payment account transaction (authorization request/authorization response, etc.)

It may vary from device to device or transaction to transaction as to whether the customer loyalty ID card or the payment account transaction card is the first card to be read by the point of sale terminal 106a. (It will also be recalled that what has been referred to as a “customer loyalty ID card” in the previous sentence may also be used itself as a payment card for initiating payment transactions, according to some embodiments.)

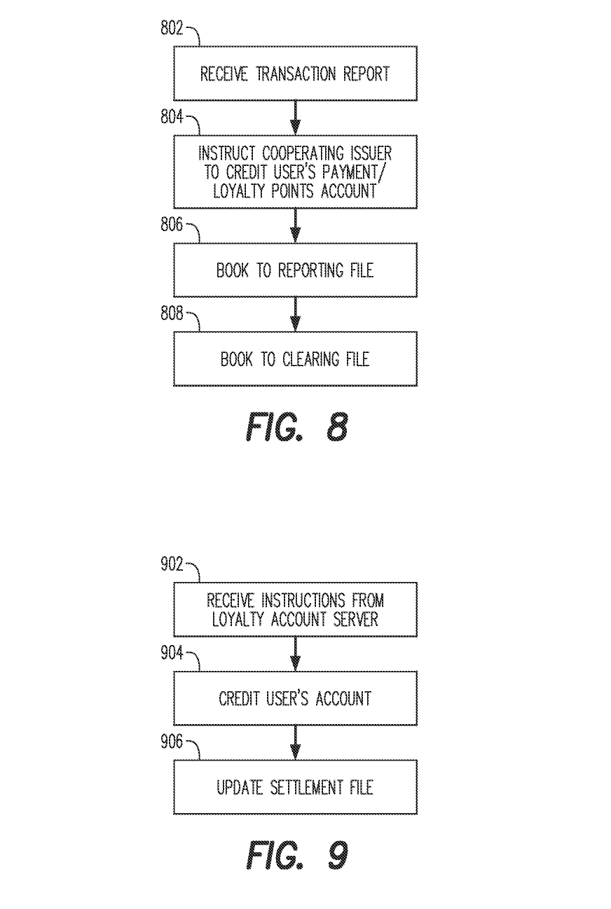

FIG. 8 is a flow chart that illustrates a process that may be performed by the loyalty accounts server computer 304 in accordance with some aspects of the customer loyalty system disclosed herein.

At 802 in FIG. 8, the loyalty accounts server computer 304 receives a report of a transaction. As will be understood from previous discussion, the report may have been transmitted to the loyalty accounts server computer 304 from the point of sale terminal 106a, from the acquirer computer 602, from the issuer 112a or from the payment network 110a. In some embodiments the report may have been transmitted to the loyalty accounts server computer 304 by an account issuer with respect to a payment account transaction that does not involve the payment network 110a. (That is, in this latter circumstance, the transaction may involve a payment account not issued under the payment network brand associated with the payment network 110a, and may be from an issuer of payment accounts under a brand different from the brand associated with the payment network 110a.) In some embodiments, the same transaction may be reported to the loyalty accounts server computer 304 by more than one (potentially four or more) parties to the transaction, assuming that each party making the report of the same transaction participates in the system in such a manner as to fund/sponsor loyalty points for the transaction in question.

At 804, the loyalty accounts server computer 304 may instruct the loyalty accounts issuer 308 to credit loyalty points—with respect to the reported transaction—to the relevant customer loyalty account/payment account—i.e., to the account of the customer/user who engaged in the reported transaction.

At 806, the loyalty accounts server computer 304 may cause the reported transaction (and the loyalty points to be issued therefor) to be booked to a reporting file for subsequent inclusion in reporting to the user and/or other appropriate parties.

At 808, the loyalty accounts server computer 304 may cause the reported transaction and/or the applicable loyalty points to be booked to a clearing file, for subsequent settlement between the points-funders/sponsors and the loyalty account issuer 308.

FIG. 9 is a flow chart that illustrates a process that may be performed by the account issuer computer 502 in connection with aspects of the customer loyalty system disclosed herein.

At 902 in FIG. 9, the account issuer computer 502 may receive instructions from the loyalty accounts server computer 304 as to loyalty points that are to be credited to a particular customer loyalty account/payment account that has been issued by the loyalty accounts issuer 308 in connection with operation of the customer loyalty system.

At 904, the account issuer computer 502 credits the loyalty points to the indicated customer loyalty account/payment account as instructed by the loyalty accounts server computer 304. In doing so, the account issuer computer 502 may convert the loyalty points to a monetary value (e.g., according to a predetermined formula or ratio), such that the customer loyalty account/payment account—at least in its payment account aspects—is denominated in a suitable monetary amount for use in payment account transactions routed to the loyalty accounts issuer 308.

At 906, the account issuer computer 502 may update a settlement file, so that the loyalty accounts issuer can later assure itself that it has received a transfer of value from the sponsor of the points just credited to the user's account.

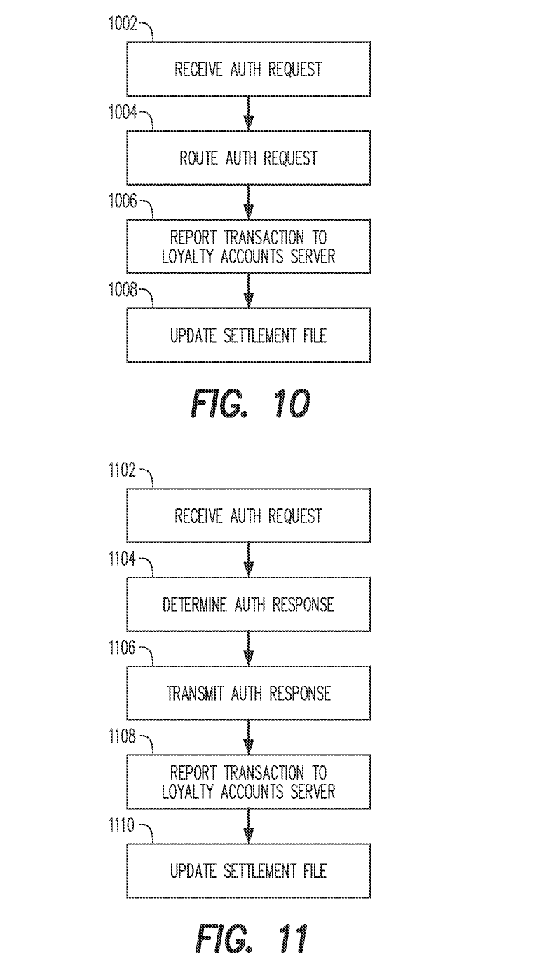

FIG. 10 is a flow chart that illustrates a process that may be performed by the acquirer computer 602 in connection with aspects of the customer loyalty system disclosed herein.

At 1002 in FIG. 10, the acquirer computer 602 may receive an authorization request. At 1004, the acquirer computer 602 may route the authorization request (via the payment network 110a) to the issuer of the payment account identified in the authorization request. At 1006, the acquirer computer 602 may report the transaction to the loyalty accounts server computer 304 so that loyalty points are credited to the account of the user who initiated the transaction. At 1008, the acquirer computer 602 may update the transaction acquirer's settlement file for loyalty points transactions, so that the transaction acquirer is prepared to confirm a subsequent transfer of value in regard to the loyalty points from the transaction acquirer to the loyalty accounts issuer.

In some embodiments, the acquirer computer 602 may report the transaction to the loyalty accounts server computer 304 before receiving the authorization response, and may reverse the report if the payment account transaction is declined. In some embodiments, the acquirer computer 602 may report the transaction to the loyalty accounts server computer 304 only when and if the acquirer computer 602 receives an authorization response that indicates approval of the transaction.

FIG. 11 is a flow chart that illustrates a process that may be performed by the account issuer 112a (FIG. 3) in connection with aspects of the customer loyalty system disclosed herein. It should be understood that the functionality disclosed in connection with FIG. 11 may be implemented with a computer or a number of cooperating computers operated by or on behalf of the account issuer 112a. The computer or computers may have the same or similar types of hardware architecture and/or hardware components as were described above in connection with FIG. 4.

At 1102 in FIG. 11, the account issuer 112a may receive an authorization request initiated by a user enrolled in the customer loyalty system disclosed herein. It is assumed that the user is seeking to engage in a payment account transaction using a payment account issued to the user by the account issuer 112a.

At 1104, the account issuer 112a may determine the details of its authorization response with respect to the authorization request received at 1102. For example, the account issuer 112a may generate an authorization response approving the requested transaction if all is in order with the transaction requested and with the payment account to be used for the transaction requested.

At 1106, the account issuer 112a may transmit the authorization response for routing back to the merchant at which the transaction was initiated.

At 1108, the account issuer 112a may report the transaction to the loyalty accounts server computer 304 so that loyalty points are credited to the account of the user who initiated the transaction. At 1110, the account issuer 112a may update its settlement file for loyalty points transactions, so that the account issuer 112a is prepared to confirm a subsequent transfer of value in regard to the loyalty points from the account issuer 112a to the loyalty accounts issuer.

A customer loyalty program as disclosed herein may be highly attractive to consumers, as they may be able to accrue loyalty points in numerous ways and from numerous parties, including—in some embodiments—several sponsoring parties involved in a single payment account transaction. In some embodiments, the rules of the customer loyalty program may be such that the value of loyalty points can easily be transferred from one user to another. For example, the transferee user may have points (or corresponding monetary value) transferred to his/her account issued by the loyalty accounts issuer, so that the transferee can readily use the payment card associated with the account to access the transferred value. Enrollment of the customer in the program may, in some embodiments, be solicited and facilitated by the customer's wallet service provider, which may also be a sponsor/funder of loyalty points. In some embodiments, the wallet service provider may be an affiliate or operating division of the operator of a payment network. In some embodiments, enrollment in the loyalty program may be open to any individual, even including those who have no other connection with the chief organizer of the program or with any other particular party or entity.

The customer loyalty program disclosed herein may also provide significant advantages for many or all of the transaction parties referred to herein and for other entities as well. For example, a payment facilitator or provider of payment-related services to small to medium sized entities (SMEs) may enroll the SMEs as points sponsors as part of a suite of payment-related services offered to SMEs. This may make it convenient and cost effective for even a very small business to offer customer loyalty rewards to its customers pursuant to the system disclosed herein. For example, the role of points sponsor may be bundled with enrollment as a payment account transaction acceptor (and with other services as well) for an SME.

In some embodiments, where a merchant is a points sponsor, the merchant POS may not report the transactions in question to the loyalty accounts server computer 304. Instead the reporting function may be taken on by the merchant's payment facilitator, so that the merchant may employ conventional POS equipment.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

As used herein and in the appended claims, a “server” includes a computer device or system that responds to numerous requests for service from other devices.

The flow charts and descriptions thereof herein should not be understood to prescribe a fixed order of performing the method steps described therein. Rather, the method steps may be performed in any order that is practicable, including simultaneous performance of at least some steps.

As used herein and in the appended claims, the term “payment card system account” includes a credit card account, a deposit account that the account holder may access using a debit card, a prepaid card account, or any other type of account from which payment transactions may be consummated. The terms “payment card system account” and “payment card account” and “payment account” are used interchangeably herein. The term “payment card account number” includes a number that identifies a payment card system account or a number carried by a payment card, or a number that is used to route a transaction in a payment system that handles debit card and/or credit card transactions. The term “payment card” includes a credit card, debit card, prepaid card, or other type of payment instrument, whether an actual physical card or virtual.

As used herein and in the appended claims, the term “payment system” refers to a system for handling purchase transactions and related transactions. An example of such a system is the one operated by MasterCard International Incorporated, the assignee of the present disclosure. In some embodiments, the term “payment system” may be limited to systems in which member financial institutions issue payment accounts to individuals, businesses and/or other organizations.

Although the present disclosure has been described in connection with specific exemplary embodiments, it should be understood that various changes, substitutions, and alterations apparent to those skilled in the art can be made to the disclosed embodiments without departing from the spirit and scope of the disclosure as set forth in the appended claims.

What is claimed is:

1. A method comprising:
establishing a loyalty points account for an account holder; and
allowing the account holder to access value held in the loyalty points account via a transaction authorized and cleared through a payment account system.

2. The method of claim 1, further comprising:
crediting value to the loyalty points account in response to activity by the account holder on a social network.

3. The method of claim 1, wherein:
said transaction authorized and cleared through the payment account system was initiated by the account holder presenting a payment card at a point of sale, said payment card for presenting an account indicator to said point of sale; said account indicator for identifying said loyalty points account.

4. The method of claim 3, wherein the account indicator is a PAN (primary account number).

5. The method of claim 3, wherein the account indicator is a payment token.

6. The method of claim 1, wherein said transaction is a first transaction;
the method further comprising:
crediting value to the loyalty points account in response to a second transaction, the second transaction reported by a transaction acquirer to cause said crediting of value, the second transaction also routed by the transaction acquirer to an account issuer, the account issuer having issued a payment account accessed for payment in the second transaction.

7. The method of claim 1, wherein the loyalty points account is issued as a payment account by an issuer of payment accounts.

8. A method comprising:
receiving a payment account transaction authorization request message at a transaction acquirer, the payment account transaction authorization request message relating to a requested payment account transaction;
routing the payment account transaction authorization request message from the transaction acquirer for delivery to an account issuer, the account issuer having issued a payment account to be accessed by the requested payment account transaction; and
the transaction acquirer transmitting a loyalty account message to a recipient, the loyalty account message transmitted by the transaction acquirer in response to receiving the payment account transaction authorization request message, the loyalty account message including at least some data from the received payment account transaction authorization request message, the recipient different from the account issuer.

9. The method of claim 8, wherein:
the transaction acquirer routes the payment account transaction authorization request message to the account issuer via a payment network; and
the transaction acquirer transmits the loyalty account message via a communication channel that is different from the payment network.

10. The method of claim 9, wherein the loyalty account message is for causing value to be credited to a loyalty points account.

11. The method of claim 10, wherein the loyalty points account belongs to a user who initiated said requested payment account transaction.

12. The method of claim 11, wherein the value to be credited to the loyalty points account is funded at least in part by a merchant that generated the payment account transaction authorization request message.

13. The method of claim 11, wherein the value to be credited to the loyalty points account is funded at least in part by the transaction acquirer.

14. The method of claim 11, wherein the value to be credited to the loyalty points account is funded at least in part by an operator of the payment network.

15. The method of claim 11, wherein the value to be credited to the loyalty points account is funded at least in part by the account issuer.

16. The method of claim 11, wherein the value to be credited to the loyalty points account is funded in part by a merchant that generated the payment account transaction authorization request message, in part by the transaction acquirer and in part by an operator of the payment network.

17. The method of claim 11, wherein:
the account issuer is a first account issuer; and
the loyalty points account is a payment account issued by a second account issuer, the second account issuer different from the first account issuer.

18. A method comprising:
receiving a report of a payment account transaction, the payment account transaction having been routed over a first payment account network operated by a first payment account network operator, the report being received by a second payment account network operator different from the first payment account network operator; and
crediting, by the second payment account network operator, value to a loyalty points account, said crediting in response to said receiving the report, the loyalty points account being a payment account accessible by a second payment account network, said second payment account network operated by the second payment account network operator and different from the first payment account network.

19. The method of claim 18, wherein said report is received from a merchant that accepted the payment account transaction.

20. The method of claim 18, wherein said report is received from an account issuer to which the payment account transaction was routed.
